(19) United States
(12) Patent Application Publication
(10) Pub. No.: US 2012/0118516 A1
(43) Pub. Date: May 17, 2012

(54) Apparatus and Methods for Creating a Barrier Between Occupants in a Side-By-Side Stroller

(76) Inventor: Monica Macauley, New Providence, NJ (US)

(21) Appl. No.: 12/948,273

(22) Filed: Nov. 17, 2010

(51) Int. Cl. B62B 9/00; B23P 11/00

(52) U.S. Cl. 160/351; 29/428

(57) ABSTRACT

Apparatus and methods for providing a barrier between occupants of a side-by-side stroller, the apparatus including a coupler and an obstruction. Couplers may clip on to stroller fabric or frame. Or, couplers include stroller interfaces that couple to the stroller frame. Couplers include two pivotably connected arms that may be adjusted to match the angle of the stroller. Couplers may include tensioning or non-tensioning length adjustment mechanisms to match the length of the portion of the stroller to which it is attached. Obstructions may be of a fixed shape, inflatable, and/or collapsible.

### BACKGROUND OF THE INVENTION

Embodiments of the present invention generally relate to apparatus and methods for providing a barrier between occupants of a side-by-side stroller. More specifically, the present invention relates to apparatus and methods for providing a barrier between occupants of a side-by-side stroller via attachment of a coupler and obstruction to the frame or other components of a side-by-side stroller.

Strollers are known as a common way to transport children. More specifically, side-by-side strollers are known for the purpose of allowing a caregiver to transport two children simultaneously with convenience. In their most basic form, side-by-side strollers are known to have wheels, a frame, and two seats. Such strollers are offered in a variety of styles with a large variety of stroller frame types. Although side-by-side strollers offer transportation convenience to caregivers with more than one child, the close proximity of the occupants seated in the stroller can result in negative interaction between the occupants. For example, poking, scratching, fighting, and the like may occur. This type of negative interaction can result in injury to the occupants in addition to potentially distracting the caregiver from the task at hand.

### BRIEF SUMMARY OF THE INVENTION

Briefly stated, in one aspect of the present invention, an apparatus for creating a barrier between occupants of a side-by-side stroller is provided. The apparatus includes: two arms; two length adjusters, each of the length adjusters attached to a respective one of the two arms; a pivoting mechanism, the two arms pivotably coupled to each other via the pivoting mechanism; two stroller interfaces, each of the stroller interfaces coupled to one of the two arms; an obstruction coupled to at least one of the group consisting of one or more of the two arms; one or more of the stroller interfaces, and combinations thereof.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a stroller with a collapsible barrier installed in accordance with one embodiment of the present invention

FIG. 2A is a perspective view of the coupler of the collapsible barrier of FIG. 1;

FIG. 2B is a partial top view of the coupler depicted in FIG. 2A;

FIG. 2C is a partial side view of the coupler depicted in FIG. 2A;

FIG. 2D is a partial cross-sectional view of the coupler depicted in FIGS. 2A through 2C taken along lines 2D-2D of FIG. 2C;

FIG. 3A is a side view of the collapsible obstruction depicted in FIG. 1 in an open position and attached to a coupler, the coupler attached to a stroller frame, wherein only a portion of the stroller is depicted;

FIG. 3B is a side view of the collapsible obstruction of FIG. 3A in a partially closed position and not attached to a coupler;

FIG. 3C is a side view of the collapsible barrier of FIG. 3A in a partially closed position having one arm of the obstruction coupled to one arm of the coupler;

FIG. 3D is an end view of the collapsible obstruction of FIG. 3A in a fully closed position;

FIG. 4A is a perspective view of an alternate tension coupler in accordance with an alternate embodiment of the present invention;

FIG. 4B is a partial top view of the tension coupler of FIG. 4A;

FIG. 4C is a partial cross-sectional view of the tension coupler of FIGS. 4A and 4B taken along lines 4C-4C of FIG. 4B;

FIG. 5A is a perspective view of a clipping coupler in accordance with an alternate embodiment of the present invention;

FIG. 5B is a partial top view of the clipping coupler of FIG. 5A;

FIG. 5C is a cross-sectional view of the clipping coupler of FIGS. 5A and 5B taken along lines 5C-5C of FIG. 5D;

FIG. 5D is an end view of the clipping coupler of FIGS. 5A, 5B, and 5C;

FIG. 6A is a perspective view of a stroller without a barrier, wherein the frame of the stroller has fabric, but no central support structure, between the seats;

FIG. 6B is a perspective view of the alternate clipping coupler of FIGS. 6C-6E installed on the stroller depicted in FIG. 6A with the obstruction removed;

FIG. 6C is a partial top view of the alternate clipping coupler of FIGS. 6B, 6D, and 6E;

FIG. 6D is a partial cross-sectional view of the alternate clipping coupler of FIGS. 6B, 6C and 6E taken along lines 6D-6D of FIG. 6B;

FIG. 6E is a top view of the support tube of the alternate clipping coupler of FIGS. 6B through 6D;

FIG. 7A is a top view of yet another clipping coupler in accordance with an alternate embodiment of the present invention;

FIG. 7B is a side view of the clipping coupler of FIG. 7A;

FIG. 7C is a cross-sectional view of the clipping coupler of FIGS. 7A and 7B taken along lines 7C-7C of FIG. 7B;

FIG. 8A is a top view of an inflatable barrier in accordance with an alternate embodiment of the present invention;

FIG. 8B is a side view of the inflatable barrier of FIG. 8A;

FIG. 8C is a bottom view of the inflatable barrier of FIGS. 8A and 8B; and

FIG. 9 depicts a flowchart of the steps of a process for attaching the coupler of FIGS. 2A through 2D to a stroller in accordance with one embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a clip” may include a plurality of clips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. Where there are discrepancies in terms and definitions used in references that are incorporated by reference, the terms used in this application shall have the definitions given herein.

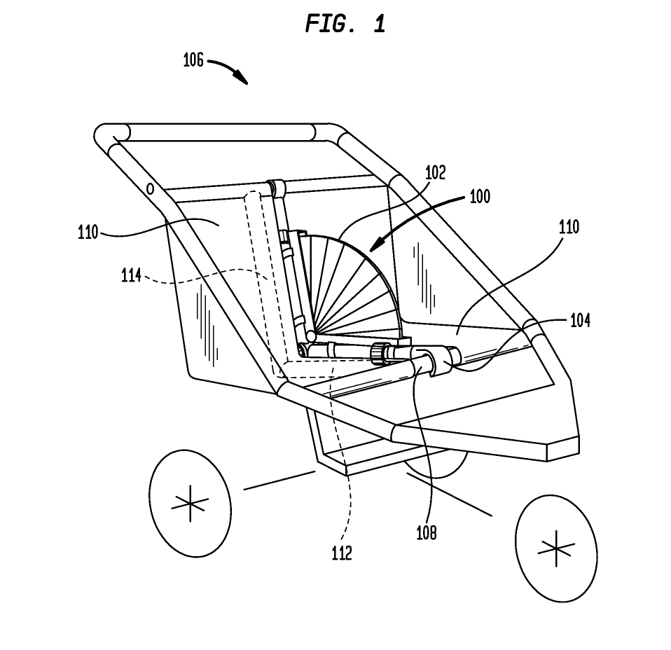

Referring first to FIG. 1, depicted is a perspective view of collapsible barrier 100 coupled to stroller 106 in accordance with one embodiment of the present invention. Barrier 100 includes obstruction 102 and coupler 104. Barrier 100 is coupled to stroller 106, the latter of which includes stroller frame 108 and seats 110. The portion of stroller frame 108 located between seats 110 includes lower section 112 and upper section 114. Barrier 100 is designed to provide a physical barrier that isolates occupants of side-by-side strollers from one another.

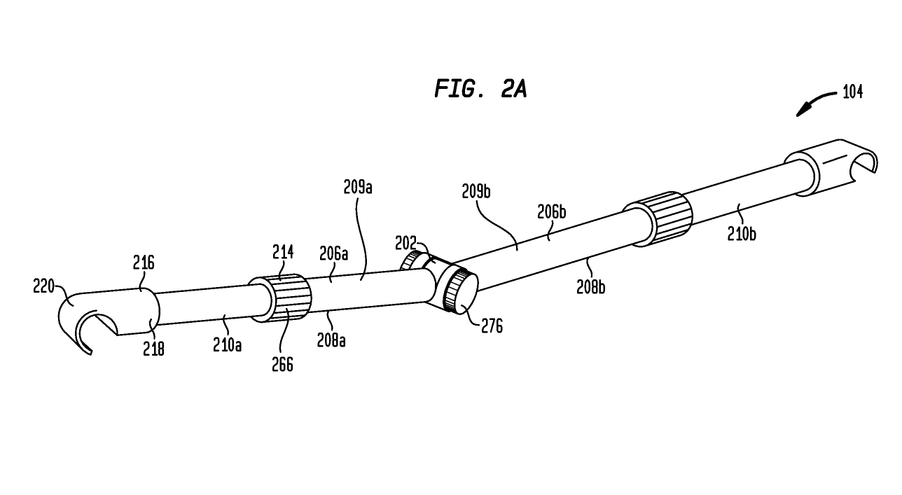

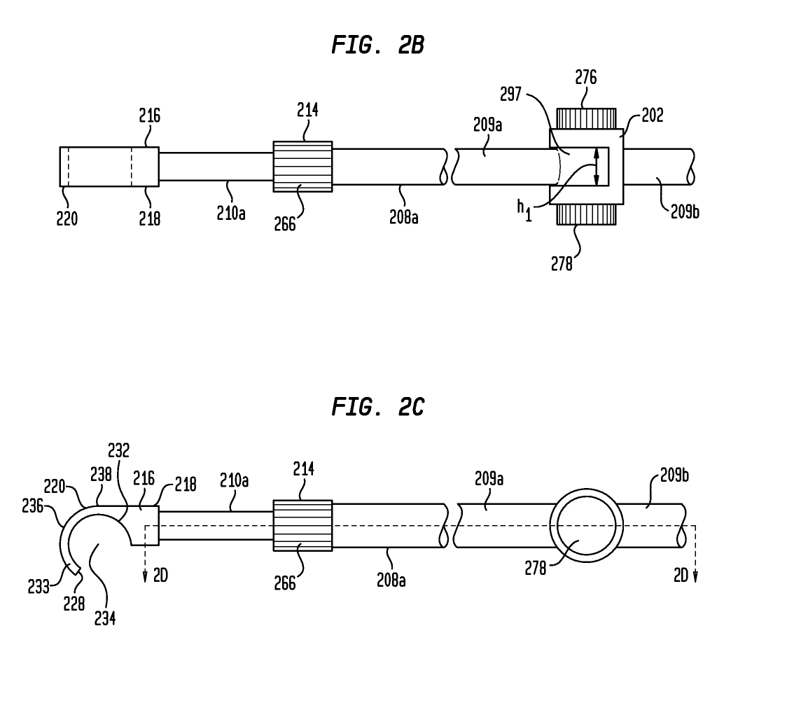

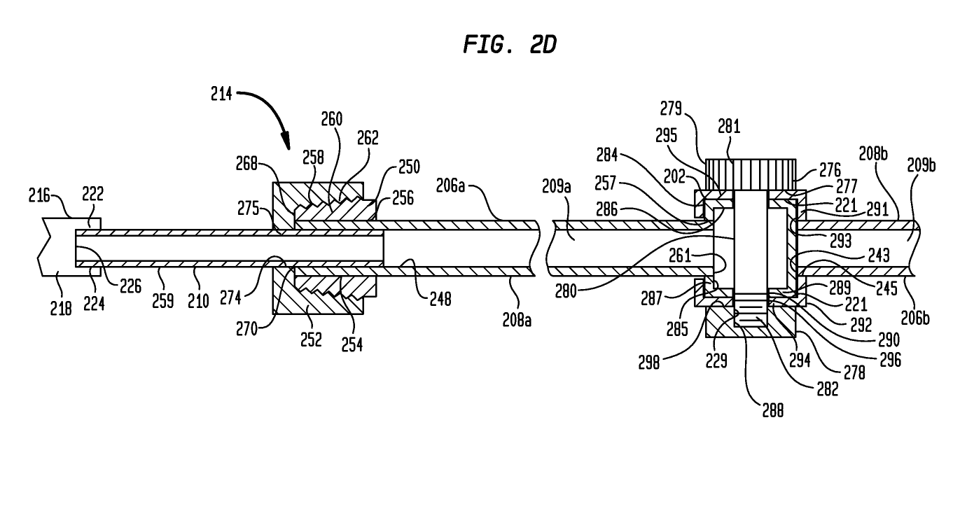

FIG. 2A depicts a perspective view of telescoping coupler 104. Coupler 104 includes, inter alia, two telescoping arms 206 connected to each other via joint 202. Arms 206 are substantially identical with the exception of the portions of each arm 206 that couple to joint 202 as discussed in further detail below. Each arm 206 includes proximal arm section 208 and distal arm section 210 joined to each other via length adjuster 214. In the depicted embodiment, length adjuster 214 is a collar, however, alternate length adjusters may be substituted without departing from the scope of the present invention.

Distal arm sections 210 are substantially tubular in shape with a substantially fixed diameter throughout their length. Proximal arm sections 208 each include a substantially tubular body 209 with a substantially fixed diameter throughout its length. Additionally, proximal arm section 208a includes substantially cylindrical body 287 and proximal arm section 208b includes substantially cylindrical body 291, both of which are discussed in further detail below.

As best seen in the cross-sectional view of FIG. 2D, the outer diameter of distal arm section 210 has a diameter almost equivalent to, but slightly smaller than, the inner diameter of proximal arm section 208. This relative sizing allows proximal arm section 208 to receive distal arm section 210 in an axially aligned sliding manner for the purpose of adjusting the length of telescoping arm 206. That is, by sliding distal arm section 210 in or out of proximal arm section 208, the user can adjust the overall length of each arm 206, and therefore coupler 104, as necessary to accommodate the size of various side-by-side strollers.

Still referring to FIG. 2D, distal arm section 210 is removably coupled to proximal arm section 208 via length adjuster 214 in an adjustable manner. Length adjuster 214 is comprised of inner collar section 250 and outer collar section 252. Inner collar section 250 includes a substantially cylindrical inwardly facing surface 254, which has a slightly larger diameter than the outer diameter of proximal arm section 208. The portion of inwardly facing surface 254 that surrounds the distal end of outwardly facing surface 256 of proximal arm section 208 may be non-removably secured thereto via any one of a variety of methods commonly known in the art including, but not limited to, welding, adhesive, etc. The outwardly facing surface of inner collar section 250 is substantially frusto-conical and includes helical threads 258. Threads 258 are designed to engage the inversely threaded central aperture 260 of outer collar section 252.

Outer collar section 252 is substantially cylindrical with a bore passing therethrough. A first section of the bore includes central aperture 260 which is frusto-conical in shape and includes inwardly facing surface 262. The inversely threaded inwardly facing surface 262 is designed to mate with threads 258. At the innermost radial edge of inversely threaded surface 262, wall 268 transitions radially inward in a substantially perpendicular manner to the axis of outer collar section 252 until it reaches inner edge 270. At inner edge 270, wall 268 intersects in a substantially perpendicular manner with substantially cylindrical inwardly facing surface 274. Inwardly facing surface 274 bounds substantially cylindrical bore 275 that extends throughout the remainder of outer collar section 252. Inwardly facing surface 274 has a slightly larger diameter than the outer diameter of distal arm section 210. This relative sizing allows distal arm section 210 to pass through bore 275 in an axially aligned manner, as it slides in or out of proximal arm section 208, when outer collar section 252 has not been tightened to render distal arm section 210 immovable. As best seen in FIGS. 2A through 2C, in the depicted embodiment, the outwardly facing surface of outer collar section includes ridges 266 to assist the user in gripping and tightening of same.

When distal arm section 210 is located at the desired length relative to proximal arm section 208, it may be locked in position via length adjuster 214. That is, when distal arm section 210 is located at the desired length relative to proximal arm section 208, outer collar section 252 is threaded onto inner collar section 250 until significant resistance is encountered. This threading generates a compressive force perpendicular to the axis of distal and proximal arm sections 210 and 208 and directed toward the axis thereof. This compressive force causes inwardly facing wall 254 to apply compressive force to the outwardly facing surface 256 of proximal arm section 208, thereby slightly compressing proximal arm section 208. In turn, this causes inwardly facing surface 248 of semi-compressible proximal arm section 208 to compress outwardly facing surface 259 of distal arm section 210, thereby preventing distal arm section 210 from sliding in or out of proximal arm section 208. In this manner, the position of distal arm section 210 is fixed relative to proximal arm 208 when inner collar section 250 is threaded far enough into outer collar section 252 to generate enough compressive force between inwardly facing wall 254 and outwardly facing surface 256 to render distal arm section 210 immovable relative to proximal arm section 208. Alternatively, when outer collar 252 is not threaded onto inner collar 250, or is loosely threaded thereto, distal arm section 210 is free to move in and out of proximal arm section 208 for adjustment purposes.

Still referring to FIG. 2D, the end of distal arm section 210 opposite joint 202 is coupled to stroller frame interface 216. Stroller frame interface 216 includes shaft 218 and head 220, the latter of which is best seen in FIGS. 2B and 2C. Shaft 218 includes recess 222, which is substantially cylindrical. Recess 222 includes substantially cylindrical inner wall 224, which has a slightly larger diameter than the outer diameter of distal arm section 210. Recess 222 also includes substantially planar inner surface 226, which is bounded by and substantially perpendicular to wall 224. Stroller frame interface 216 may be non-removably secured to outwardly facing surface 259 of distal arm section 210 via inserting the end of distal arm section 210 into recess 222 until it abuts surface 226 and securing same thereto via any one of a variety of methods commonly known in the art including, but not limited to, welding, adhesive, etc. In this manner, stroller frame interface 216 is non-removably coupled to the end of distal arm section 210 and, therefore, coupler 104.

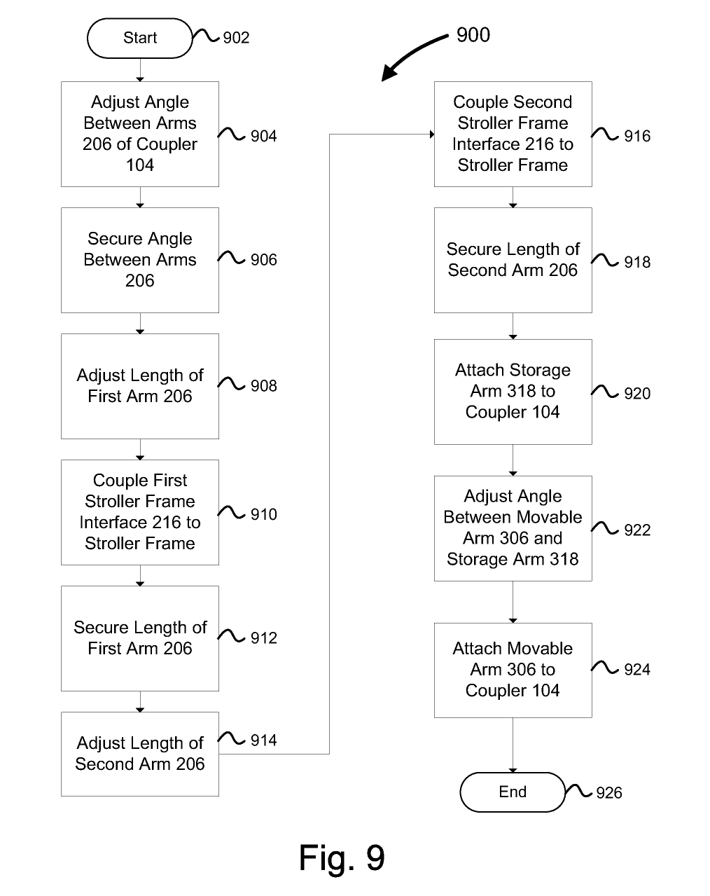

Referring now to FIG. 2C, stroller frame interface 216 includes shaft 218 and head 220. Shaft 218 is substantially cylindrical in shape. In the depicted embodiment, head 220 includes a hook such as hook 228. The inwardly facing surface 232 of hook 228 curves around in a partially cylindrical manner to create bore 234. That is, inwardly facing surface 232 extends approximately 240 degrees around the circumference of bore 234. The outwardly facing surface 236 of the outermost half of head 220 follows the same contour as inwardly facing surface 232 and maintains a constant thickness of wall 233 throughout. The outwardly facing surface 238 of the innermost half of head 220 aligns with the outwardly facing surface of cylindrical shaft 218 with the exception of the portion cutout therefrom to accommodate bore 234. The axis of bore 234 is also substantially perpendicular to the axis of shaft 218. Bore 234 is provided to receive the frame of a stroller such as stroller 106 as further discussed below with reference to FIG. 9.

Turning back to FIG. 2D, depicted is a cross-sectional view of joint 202 as taken along lines 2D-2D of FIG. 2C. As depicted, joint 202 includes, inter alia, bolt 276 and nut 278. Bolt 276 includes head 279 and substantially cylindrical shaft 280. Head 279 is substantially cylindrical in shape with a substantially planar inwardly facing surface 277 (i.e., in the direction of first and second arms 206a and 206b, respectively) and a plurality of parallel ridges 281 on the outwardly facing surface of head 279 and aligned with the longitudinal axis of bolt 276. Ridges 281 are provided to allow a user of coupler 104 to grasp head 279 with sufficient friction to sufficiently tighten bolt 276 relative to nut 278 such that it renders arms 206 immobile relative to each other when the angle between arms 206 is fixed as discussed in further detail below with reference to FIG. 9. Shaft 280 is also substantially cylindrical in shape with a smaller diameter than head 279. The bottommost outwardly facing surface of shaft 280 includes threads 282.

Nut 278 is substantially cylindrical in shape with an inwardly facing surface 298 (i.e., in the direction of first and second arms 206a and 206b, respectively). Inwardly facing surface 298 includes a centrally located, threaded recess 288. The inwardly facing wall of threaded recess 288 is inversely threaded to receive and mate with threads 282 of the bottommost outwardly facing surface of shaft 280. This facilitates coupling of bolt 276 and nut 278.

As discussed above, each arm 206 of coupler 104 is substantially identical with the exception of the portion of each arm 206 that couples to joint 202 (i.e., the arm's proximal end). The proximal end of proximal arm section 208a includes first arm cylindrical body 287. The axis of first arm cylindrical body 287 is positioned substantially perpendicular to the axis of first arm 206a.

First arm cylindrical body 287 has a substantially cylindrical outwardly facing surface 284 and a substantially cylindrical inwardly facing surface 285. A first end of first arm cylindrical body 287 includes substantially circular, substantially planar end wall 289, which is bounded by the periphery of a first end of outwardly facing surface 284. A second end of first arm cylindrical body 287 includes substantially circular, substantially planar end wall 286, which is bounded by the periphery of a second end of outwardly facing surface 284. Each of walls 289 and 286 include central apertures 290 that are substantially circular in shape with a diameter slightly larger than the diameter of shaft 280 of bolt 276. This relative sizing allows bolt 276 to easily pass therethrough.

The side wall of first arm cylindrical body 287 are approximately equal in thickness to the wall of tubular body 209a, and it includes a cylindrical aperture 257 through which the proximal end of substantially tubular body 209a passes until end surface 261 of tubular body 209a is substantially aligned with inwardly facing surface 285. Tubular body 209a is non-removably secured to first arm cylindrical body 287 via any one of a variety of methods commonly known in the art including, but not limited to, welding, adhesive, etc.

Coupled to the proximal end of proximal arm section 208b is second arm cylindrical body 291. The axis of second arm cylindrical body 291 is positioned substantially perpendicular to the axis of second arm 206b.

Second arm cylindrical body 291 has a substantially cylindrical outwardly facing surface 292 and a substantially cylindrical inwardly facing surface 293. Inwardly facing surface 293 has a diameter almost equivalent to, but slightly larger than, the outer diameter of outwardly facing surface 284 of first arm cylindrical body 287. This relative sizing allows first arm cylindrical body 287 to fit inside and rotate within second arm cylindrical body 291 as discussed in greater detail below. A first end of second arm cylindrical body 291 includes substantially circular, substantially planar end wall 294, which is bounded by the periphery of a first end of outwardly facing surface 292. A second end of second arm cylindrical body 291 includes substantially circular, substantially planar end wall 295, which is bounded by the periphery of a second end of outwardly facing surface 292. Both walls 294 and 295 are substantially perpendicular to outwardly facing surface 292 and inwardly facing surface 293. Each of walls 294 and 295 includes a substantially circular central aperture 296 and a substantially planar inwardly facing surface 221. Central apertures 296 have a diameter that is substantially equal to the diameter of aperture 290 of first arm cylindrical body 287 and is slightly larger than the diameter of shaft 280 of bolt 276. This relative sizing allows bolt 276 to easily pass therethrough. Inwardly facing surface 221 proceeds radially outward from central apertures 296 until it intersects cylindrical inwardly facing surface 292 in a substantially perpendicular manner.

The side wall of second arm cylindrical body 291 is approximately equal in thickness to the wall of tubular body 209b, and it includes a cylindrical aperture 245 through which the proximal end of substantially tubular body 209b passes until end surface 243 of tubular body 209b is substantially aligned with inwardly facing surface 293. The proximal end of tubular body 209b is non-removably secured to second arm cylindrical body 291 via any one of a variety of methods commonly known in the art including, but not limited to, welding, adhesive, etc.

Additionally, as best seen in FIGS. 2A and 2B, second arm cylindrical body wall includes a rectangular aperture 297. Rectangular aperture 297 has a height h₁ that is slightly larger than the diameter of tubular body 209a. Rectangular aperture 297 has a width that extends around the circumference of second arm cylindrical body 291 to an extent that is adequate to allow a user to rotate first arm 206a between 0 degrees and 180 degrees relative to second arm 206b. In the depicted embodiment, rectangular aperture 297 extends throughout the entire circumference of second arm cylindrical body 291 with the exception of an area slightly larger than that through which tubular body 209b passes.

As depicted in FIG. 2D, first arm cylindrical body 287 is located inside of second arm cylindrical body 291, and it is non-removable coupled to proximal section 208a such that proximal section 208a passes through rectangular aperture 297. With this configuration, as first arm 206a is rotated relative to second arm 206b, first arm 206a causes the first arm cylindrical body 287 to rotate within second arm cylindrical body 291 until the proper angle between the two arms is obtained. In the configuration discussed above, joint 202, cylindrical body 291 and cylindrical body 287 form a pivoting mechanism that pivotably couple arms 206 and allows the angle therebetween to be adjusted.

As discussed in further detail below with regards to FIG. 9, once first arm 206a has been properly positioned relative to second arm 206b, the user may fix the angle therebetween by threading threads 282 of bolt 276 into the inversely threaded wall 229 of recess 288 until significant resistance is encountered. This threading causes bolt 276 and nut 278 to apply an inward compressive force parallel to the axis of first arm cylindrical body 291 that squeezes first arm 206a and second arm 206b until they are rendered immobile. That is, the substantially planar inwardly facing surface 277 of head 279 of bolt 276 applies pressure to the outwardly facing surface of wall 295 and inwardly facing surface 298 of nut 278 simultaneously applies pressure to wall 294, thereby slightly compressing second arm cylindrical body 291. The compression of second arm cylindrical body walls 295 and 294 causes the inwardly facing surfaces of second arm cylindrical body walls 295 and 294 to move inward and contact the outwardly facing surfaces of first arm cylindrical body walls 286 and 294, respectively, thereby applying compressive force thereto. This compressive force renders first arm 206a immovable relative to second arm 206b.

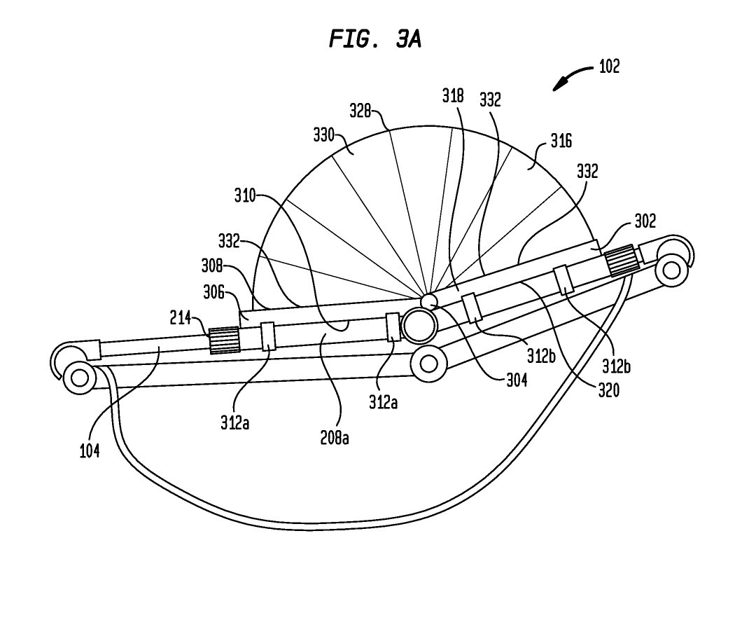

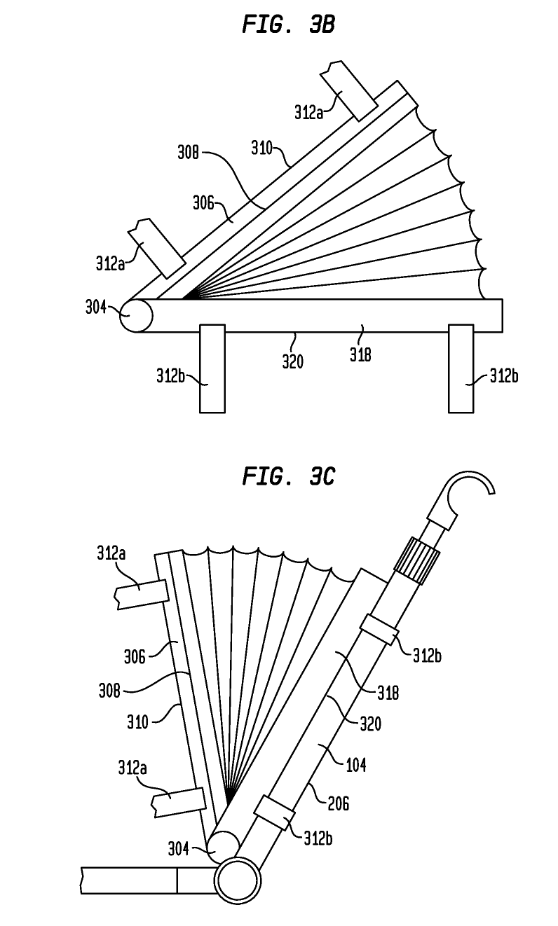

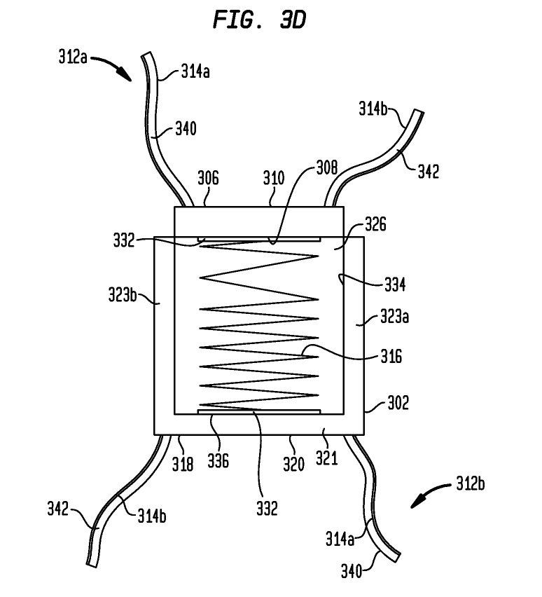

Turning next to FIGS. 3A though 3D, depicted is one embodiment of a collapsible obstruction 102. Obstruction 102 includes frame 302 and fan 316. Frame 302 provides support for obstruction 102 and allows it to be coupled to a stroller via a coupler such as coupler 104. Fan 316 is constructed of collapsible material of sufficient thickness to provide a strong obstruction including, but not limited to, canvas. That is, fan 316 is constructed of a resilient collapsible material of a thickness that prevents stroller occupants from bending, damaging, or otherwise disrupting obstruction 102.

Fan 316 is created by folding a flat sheet of such material to include a plurality of creases 328 that form a plurality of substantially rectangular fan sections 330. Fan sections 330 are designed to be approximately the same size as inwardly facing surface 308 of movable arm 306 and upwardly facing surface 336 of storage arm 318, as best seen in and as discussed in further detail below with respect to FIG. 3D. When in an open position, the fan sections are expanded to cumulatively form a large, approximately semi-circular physical obstruction for use between occupants in side-by-side strollers. When folded to a closed position, each crease 328 causes a section 330 of fan 316 to fold upon the previous section, thereby forming a plurality of stacked layers as best depicted in FIG. 3D. Each fan section 330, therefore, lies on the previous fan section when obstruction 102 is in a closed position.

In the depicted embodiment, frame 302 includes movable arm 306 and storage arm 318, which are coupled to opposing sides of hinge 304. Hinge 304 is provided to allow movable arm 306 and storage arm 318 to be folded at an angle that approximates the angle of the frame of a stroller. As obstruction 102 is opened, sections 330 of fan 316 are unfolded. That is, as the angle between arm 306 and storage arm 318 is increased, the distance between each of the sections 330 in each layer of fan 316 is increased, thereby increasing the size of obstruction 102.

A first side of hinge 304 is coupled to the proximal end of movable arm 306. As best seen in FIGS. 3B and 3D, movable arm 306 is substantially rectangular and has substantially planar inwardly facing surface 308 and substantially planar outwardly facing surface 310. A second side of hinge 304 is coupled to the proximal end of storage arm 318. Storage arm 318 is in the form of a rectangular channel, and it includes bottom wall 321 and two (2) sides 323a and 232b. Bottom wall 321 has a substantially planar outwardly facing surface 320. Sides 323 are substantially parallel to each other and intersect bottom wall 321 in a substantially perpendicular manner. Bottom wall 321 and sides 323 form channel 326, which extend throughout the entire length of storage arm 318. As best seen in FIG. 3D, channel 326 is substantially rectangular and includes substantially planar inwardly facing surfaces 334 and substantially planar upwardly facing surface 336. Channel 326 is provided to store fan 316 in a protective and collapsed manner when obstruction 102 is not in use and is in a closed position.

Movable arm 306 includes two pairs of attachment mechanisms 312a attached to opposing ends of the outwardly facing surface 310 of movable arm 306. Similarly, storage arm 318 includes two pairs of attachment mechanisms 312b attached to the outwardly facing surface 320 of opposing ends of storage arms 318. Attachment mechanisms 312 are provided to facilitate coupling of obstruction 102 to coupler 104 as described in greater detail below as well as retention of obstruction 102 in a collapsed position during storage thereof.

As best seen in FIGS. 3B and 3D, fan 316 is coupled to frame 302 via attachment of endmost sections 332 of fan 316 to inwardly facing surface 308 of movable arm 306 and upwardly facing surface 336 of storage arm 318 via any one of a variety of methods commonly known in the art including, but not limited to, snaps, Velcro®, other hook and lock fasteners, adhesive, etc.

Still referring to FIGS. 3A through 3D, attachment mechanisms 312a and 312b each include two substantially rectangular flat straps 314a and 314b. Each strap 314a has loops on its inwardly facing surface 340 (i.e., the side facing strap 314b as best seen in FIG. 3D). Each strap 314b has hooks on its outwardly facing surface 342 (i.e., the side facing away from strap 314a as best seen in FIG. 3D) that are designed to mate with the loops of the respective inwardly facing surface 340. Each pair of straps 314a and 314b is coupled to opposing sides of their respective arms at the approximately same longitudinal location. This allows each pair of straps to be wrapped around a respective portion of a coupler such as coupler 104 such that the hooks on outwardly facing surface 342 of straps 314b are engaged with the loops on inwardly facing surface 340 of straps 314a to secure obstruction 102 to the coupler. Although attachment mechanism 312 is depicted as a hook and loop fastener, alternate embodiments are envisioned including, but not limited to, straps with snaps, ties, etc. Additionally, attachment mechanism 312 may be located in other locations without departing from the scope of the present invention.

In addition to facilitating attachment of obstruction 102 to coupler 104, attachment mechanism 312 may be used when storing obstruction 102. That is, when obstruction 102 is in a closed position as depicted in FIG. 3D, the user may couple the attachment mechanisms 312 of movable arm 306 to the attachment mechanism 312 of storage arm 318 via engagement of the loops of straps 314a with the hooks of straps 314b. Specifically, the loops on inwardly facing surface 340 of strap 314a of movable arm 306 are engaged with the hooks on outwardly facing surface 342 of strap 314b of storage arm 318 and the loops on inwardly facing surface 340 of strap 314a of storage arm 318 are engaged with the hooks on outwardly facing surface 342 of strap 314b of movable arm 306. That is, the opposing configuration of straps 314a and 314b on outwardly surfaces 310 and 320 allow the user to so engage the hook and loop fasteners of attachment mechanisms 312 when obstruction 102 is in a closed position (i.e., a position in which the angle between arm 306 and arm 318 is almost zero). As best seen in FIGS. 3C and 3D, in this position, fan 316 is contained within channel 326 and beneath arm 306.

Referring now to FIG. 9, depicted is a flowchart of the steps of an exemplary method 900 for installing a barrier on a side-by-side stroller. Method 900 begins at 902, at which a user desires to install a barrier. This method will be described with respect to the obstruction 102 and coupler 104 shown in FIGS. 1 through 3 but the method may be used with other embodiments of the present invention as applicable. Next, at step 904, the user adjusts the arms of the coupler 104 (e.g., adjusts the angle between arms 206 of coupler 104). That is, the user grasps each of two identical arms such as arms 206 and increases or decreases the angle therebetween until an angle approximately equal to the angle of frame 108 (i.e., the portion of frame 108 located between seats 110) is achieved. This step is required because the angles of the frames 108 located between the seats 110 of various side-by-side strollers are different.

Next, at step 906, the angle between arms 206 is secured. That is, in our exemplary embodiment, the user grasps ridges 281 of head 279 and the outwardly facing surface of nut 278. The user then holds head 279 in a fixed position and rotates nut 278 in a clockwise direction relative to the position of head 279, thereby threading threads 282 of bolt 276 into the inversely threaded wall 229 of recess 288 of nut 278. As further discussed above with reference to FIG. 2D, threading of threads 282 into inversely threaded wall 229 decreases the distance between head 279 and nut 278 and generates compressive force between inwardly facing surfaces 221 of second arm cylindrical body 291 and walls 289 and 286, respectively, of first arm cylindrical body 287. Therefore, to secure the positions of arms 206 relative to each other, nut 278 is rotated until significant resistance is encountered and sufficient compressive force is generated to render arms 206 immovable relative to each other.

Next, at step 908, the length of a first telescoping arm 206 is adjusted. The user grasps a first distal arm section 210 and pulls it out of proximal arm section 208 until it is approximately equal in length to the lower section 112 of stroller frame 108. That is, the user adjusts the length of a first arm 206 until hook 228 of stroller frame interface 216 is adjacent to the end of stroller frame 108 in a position to be coupled thereto. Such a length is required to couple stroller frame interfaces 216 to the end of stroller frame 108.

Next, at step 910, stroller frame interface 216 is coupled to stroller frame 108. That is, hook 228 is placed over a portion of stroller frame 108, the latter of which is retained within bore 234. After hook 228 is coupled to the end of stroller frame 108, the overall length of the first arm 206 may be secured. The overall length of arm 206 is best secured after hook 228 is fastened to stroller frame 108 as the user may move distal arm section 210 in and out of proximal arm section 208 a short distance as they are coupling hook 228 to stroller frame 108.

At step 912, the overall length of a first arm 206 is secured by rotation of outer collar section 252 until significant resistance is encountered. Outer collar section 252 is rotated in a clockwise direction relative to the position of inner collar section 250, thereby threading inner collar section 250 into outer collar section 252. As discussed in more detail above with reference to FIG. 2D, threading of inner collar section 250 into outer collar section 252 generates compressive force on the outwardly facing surface 256 of distal arm section 210, thereby rendering it immovable relative to the position of proximal arm section 208. Therefore, to secure the overall length of an arm 206, the user rotates outer collar section 252 until significant resistance is encountered and distal arm section 210 will no longer slide in and out of proximal arm section 208. The telescoping arm 206 located adjacent to the lower section 112 is adjusted and secured prior to the telescoping arm 206 located adjacent to the upper section 114 of the stroller frame 108 between seats 110. However, a method of the present of the invention is envisioned in which a user adjusts and secures the length of the telescoping arm 206 located adjacent to upper section 114 prior to the telescoping arm 206 location adjacent to lower section 112. Regardless of the order in which the length of each telescoping arm 206 is adjusted and secured, for ease of operation, the user may adjust and then secure each arm 206 prior to manipulation of the opposite arm.

Next, method 900 proceeds to step 914, at which the length of a second telescoping arm 206 is adjusted. The user grasps a second distal arm section 210 and pulls it out of proximal arm section 208 until it is approximately equal in length to the upper section 114 of stroller frame 108 located between seats 110. That is, the user adjusts the length of a second arm 206 until hook 228 of stroller frame interface 216 is located adjacent the portion of stroller frame 108 located between seats 110 in a position to be coupled thereto. Next, at step 916, a second stroller frame interface 216 is secured to stroller frame 108 in the same manner as discussed above with reference to step 910. Then, at step 918, the overall length of a second telescoping arm 206 is secured as discussed above with reference to step 912.

Next, at step 920, storage arm 318 of obstruction 102 is attached to a first arm 206 of coupler 104 via engagement of attachment mechanism 312. Specifically, the user wraps strap 314b around arm 206, thereby placing the hooks of outwardly facing surface 342 in an outwardly facing position in order to engage the loop portion of inwardly facing surface 340. The user then places the inwardly facing surface 340 of strap 314a over strap 314b, thereby engaging the hooks and loops of straps 314a and 314b. So engaged, attachment mechanism 312 removably secures storage arm 318 to coupler 104.

Then, at step 922, the angle between movable arm 306 and storage arm 318 is adjusted to an angle that approximates the angle of coupler 104, and therefore, stroller frame 108. As movable arm 306 is rotated about hinge 304, the sections of fan 316 are expanded to cumulatively form a large, approximately semi-circular physical barrier. That is, as the user increases the angle between movable arm 306 and storage 318, the distance between each crease 328 is increased, thereby un-stacking fan sections 330 and forming a physical barrier.

Finally, at step 924, movable arm 206 of obstruction 102 is attached to a second arm 206 of coupler 104 via the engagement of attachment mechanism 312 as further discussed above with reference to step 920. The method then ends at 926.

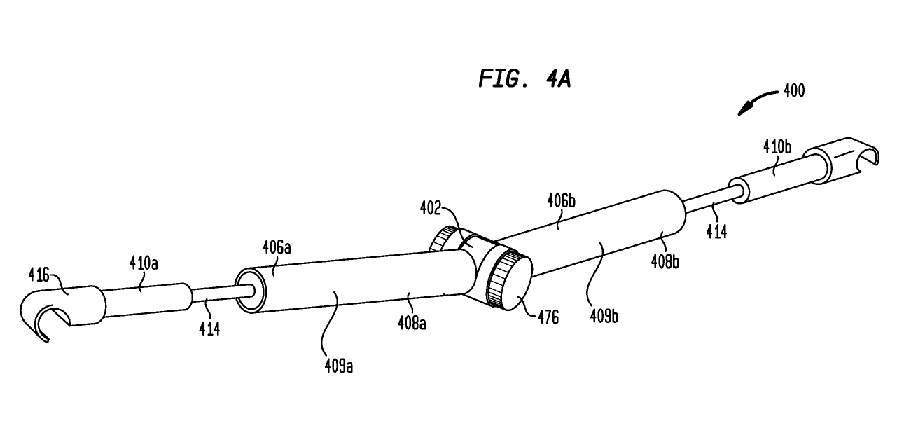

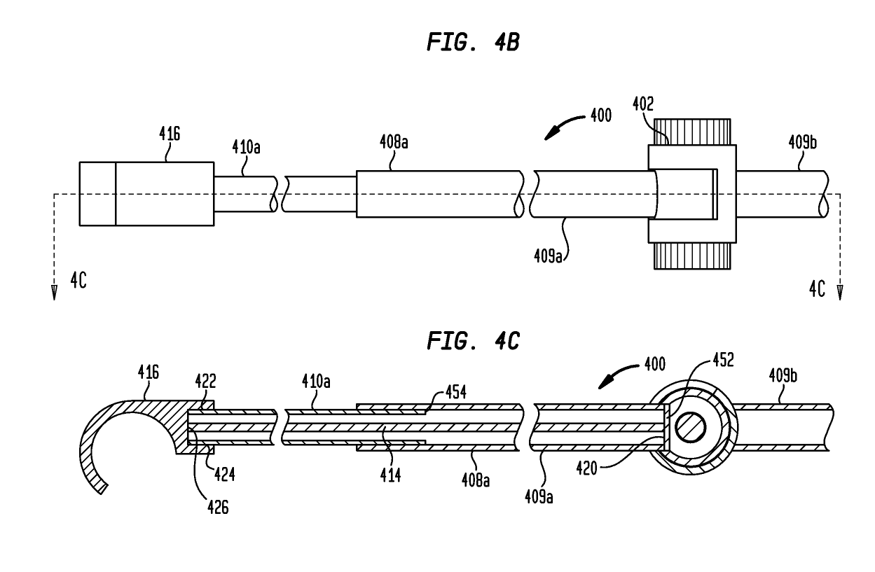

Turning now to FIGS. 4A through 4C, depicted is a perspective view of an alternative tension coupler 400. Coupler 400 includes, inter alia, two telescoping arms 406 connected to each other via joint 402. Joint 402 is substantially identical to and operates in substantially the same manner as joint 202 as described in greater detail above with respect to FIGS. 2A through 2D. That is, bolt 476 and nut 478 of joint 402 (not shown) are substantially identical to bolt 276 and nut 278 of joint 202, as described in greater detail above with respect to FIGS. 2A through 2D.

Each telescoping arm 406 includes stroller interface 416, distal arm section 410, length adjuster 414, and proximal arm section 408. Stroller interface 416 is substantially identical to and operates in substantially the same manner as stroller frame interface 216 as described in greater detail above with respect to FIGS. 2A through 2D. Distal arm section 410 is also substantially identical to distal arm section 210 as described in greater detail above with respect to FIGS. 2A through 2D with the exception that its proximal end is not encircled by length adjuster 214. Rather, it is held in communication with proximal arm section 408 via length adjuster 414.

Proximal arm section 408a of first arm 406a, and the components thereof (e.g., tubular body 409a and first arm cylindrical body 487), are substantially identical to proximal arm section 208a of first arm 206a, and the respective components thereof (e.g., tubular body 209a and first arm cylindrical body 287), as described in greater detail above with respect to FIGS. 2A through 2D with the exception that tubular body 409a includes end wall 452 (FIG. 4C) at the end to which joint 402 is coupled. End wall 452 is circular, is bounded by the outer periphery of first tubular body 409a, and has a thickness approximately equal to the wall of tubular body 409a.

Similarly, proximal arm section 408b of second arm 406b, and the components thereof (e.g., tubular body 409b and second arm cylindrical body 491), are substantially identical to proximal arm section 208b of second arm 206b, and the components thereof (e.g., tubular body 209b and second arm cylindrical body 291), as described in greater detail above with respect to FIGS. 2A through 2D with the exception that second proximal arm section 408b includes an end wall (not shown) substantially identical to end wall 452 of first arm 206a as discussed above.

Each proximal arm section 408 is attached to its respective distal arm section 410 via length adjuster 414. Proximal and distal arm sections 408 and 410, respectively, are substantially tubular in shape with a substantially fixed diameter throughout their length. As best seen in the cross-sectional view of FIG. 4C, the outer diameter of distal arm section 410 has a diameter almost equivalent to, but slightly smaller than, the inner diameter of proximal arm section 408. This relative sizing allows proximal arm section 408 to receive distal arm 410 in an axially aligned sliding manner for the purpose of adjusting the length of telescoping arm 406. That is, by sliding distal arm section 410 in and out of proximal arm 408, the user can adjust the overall length of each arm 406, and, therefore, coupler 400 as necessary to accommodate the varying sizes of side-by-side strollers.

Distal arm section 410 is non-removably coupled to proximal arm section 408 in an adjustable manner via length adjuster 414. In the depicted embodiment, length adjuster 414 is an elastic cord such as a ^{Bungee}® cord but the invention is not so limited. That is, length adjuster 414 is a substantially cylindrical cord comprised of an elastomeric material capable of stretching and retracting as distal arm section 410 is slid in and out of proximal arm section 408. As best seen in FIG. 4C, a first distal end of length adjuster 414 is non-removably secured to the inner surface 426 of stroller frame interface 416, the latter of which is also coupled to distal arm section 410. Recess 422, inner wall 424 and inner surface 426 of stroller frame interface 416 are substantially identical to recess 222, inner wall 224, and inner surface 226, respectively, of stroller frame interface 216 as further discussed above with respect to FIG. 2D.

A second proximal end of length adjuster 414 is non-removably secured to the inwardly facing surface 420 of end wall 452. When stroller frame interface(s) 416 are not attached to a stroller frame, distal arm sections 410 are retracted into their respective proximal arm sections 408 until the proximal ends 454 of distal arms section 410 contact surfaces 452. However, the elastomeric nature of length adjuster 414 allows a user to slide distal arm sections 210 out of proximal arm sections 208 until a desired length is achieved. When distal arm sections 410 are located at the desired length relative to proximal arm section 408, stroller frame interfaces 416 are coupled to the stroller frame. That is, stroller frame interfaces 416 are clipped to the frame of a stroller as further discussed above with reference to FIG. 9. Length adjuster 414 continuously attempts to retract distal arm sections 410 into their respective proximal arm sections 408, thereby holding stroller frame interfaces 416 firmly in place on the stroller frame and maintaining tension therebetween. In this manner, the elastomeric nature of length adjuster 414 provides sufficient tension to prevent stroller frame interfaces 416 from dislodging from the stroller frame, thereby holding stroller frame interface 416, coupler 400, and associated obstruction (e.g., obstruction 102) firmly in place between occupants of a side-by-side stroller.

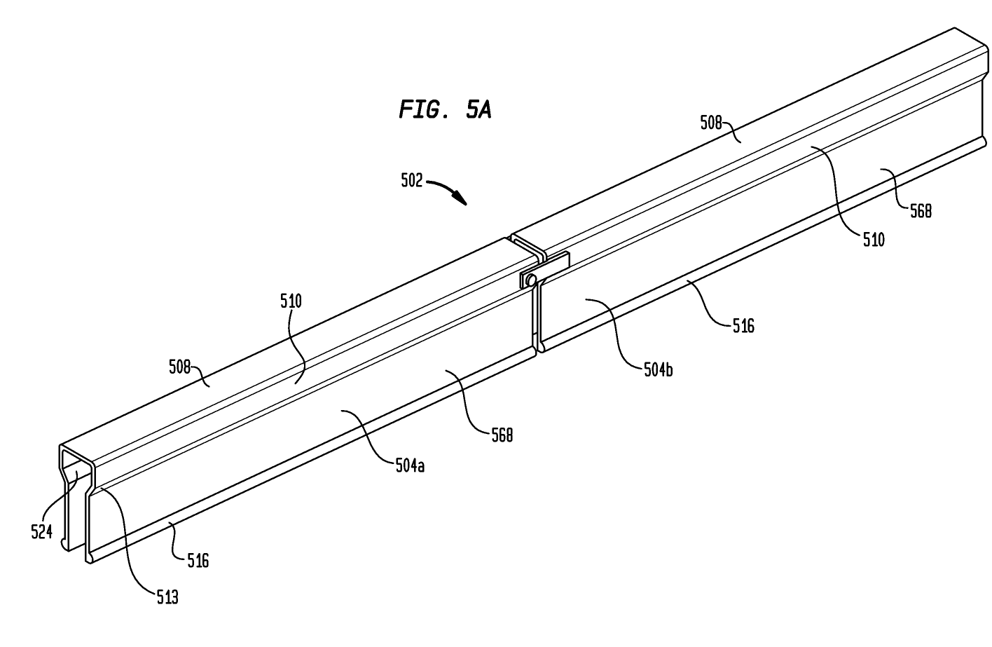

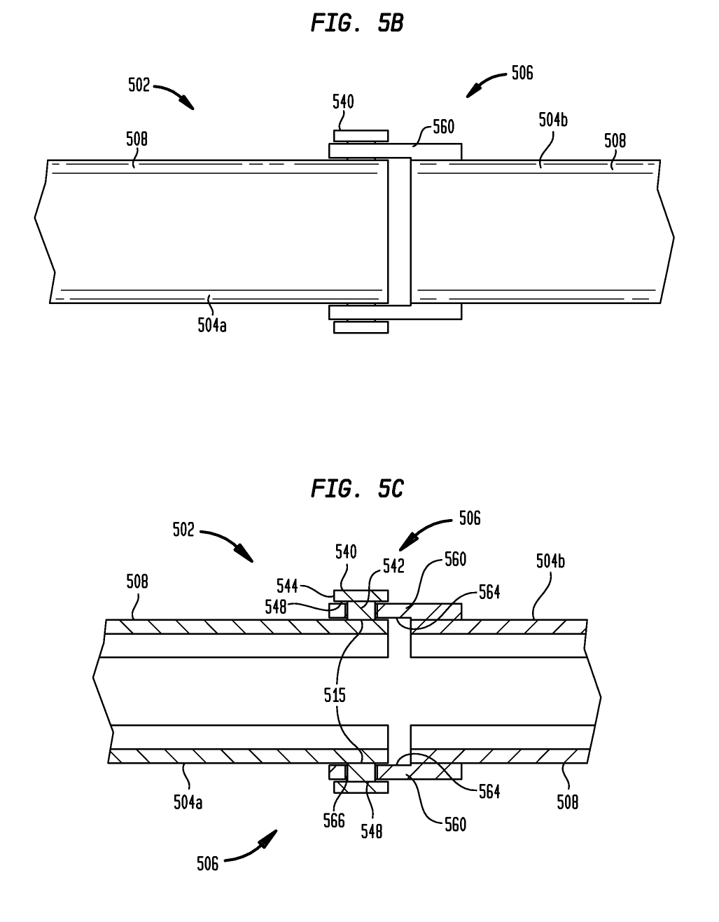

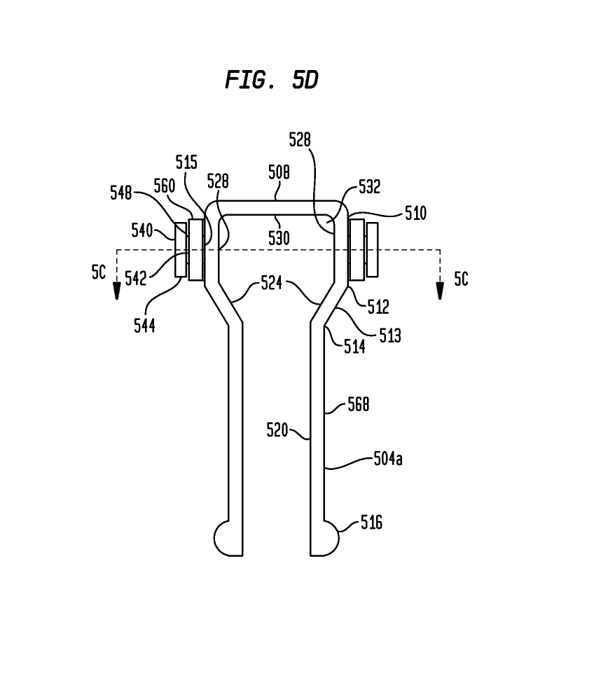

Turning now to FIGS. 5A-5D, depicted is a clipping coupler 502 in accordance with another embodiment of the present invention. Coupler 502 is designed for use with side-by-side strollers having a frame between the seats to which coupler 502 may clip. Coupler 502 includes two pivoting arms 504 and a joint 506. Each arm 504 is substantially identical with the exception of the portion of each arm 504 that couples to joint 506.

As best seen in FIG. 5A, each arm 504 is substantially linear and has a substantially planar top wall 508. As depicted in FIG. 5D, substantially planar upper walls 510 extend downward in a manner substantially perpendicular from the outer longitudinal edges of top wall 508 until edge 512, at which they intersect longitudinally with middle walls 513. Middle walls 513 converge inward and downward until edge 514 at an angle of approximately 30 degrees. Then, at edge 514, substantially planar lower walls 568 extend downward in a manner substantially perpendicular to top wall 508.

Beads 516 are semi-spherical and extend across the entire length of the bottommost outwardly facing edge of lower walls 568. Beads 516 are provided to strengthen the bottommost edges of lower walls 568 when coupling coupler 502 to a stroller frame as discussed in greater detail below. That is, beads 516 provide additional thickness to the material located at the bottommost outwardly facing edges of lower walls 568, which thereby adds additional strength. Inwardly facing surfaces 524, 528, and 530 of middle walls 513, upper walls 510, and top wall 508, respectively, bound cavity 532. As discussed in greater detail below, the stroller frame is retained within cavity 532 when coupler 502 is attached to a stroller.

Arms 504 are constructed of a material possessing sufficient flexibility to allow the portion of a frame of a side-by-side stroller located between the seats of such stroller to pass between inwardly facing surfaces 520 as discussed in further detail below. Suitable material from which to manufacture arms 504 includes, but is not limited to, polypropylene.

As best depicted in the top and cross-sectional views of FIGS. 5B and 5C, respectively, the angle between arms 504 may be adjusted to conform to the angle of the portion of a frame of a side-by-side stroller located between the seats of such stroller via joint 506. Joint 506 is comprised of pivot assembly 540 and pivot interface 560, which are coupled to arms 504a and 504b, respectively, of clipping coupler 502.

As best depicted in FIGS. 5C and 5D, the components of pivot assembly 540 are coupled to the proximal ends of the approximate vertical midpoint of the outwardly facing surfaces of upper walls 510 of first arm 504a. The components of pivot assembly 540 include two (2) substantially cylindrical pivots 542 and two (2) substantially cylindrical stops 544, both of which have axes that are substantially perpendicular to the axis of arm 504a. Substantially planar inwardly facing surfaces 515 (i.e., in the direction of first and second arms 504a and 504b, respectively) of pivots 542 are coupled to the outwardly facing surfaces of upper walls 510 via any one of a variety of methods commonly known in the art including, but not limited to, welding, adhesive, etc. Similarly, substantially planar inwardly facing surfaces 548 of stops 544 are coupled to the outwardly facing surfaces (i.e., in the direction opposite of first and second arms 504a and 504b, respectively) of pivots 542 via any one of a variety of methods commonly known in the art including, but not limited to, welding, adhesive, etc. The diameter of stops 544 is larger than the diameter of pivots 542 to maintain communication between pivot interfaces 560 and pivots 542 (i.e., stops 544 prevent pivot interfaces 560 from disengaging pivots 542 via sliding or the like).

As best depicted in FIGS. 5A and 5C, each pivot interface 560 is substantially rectangular in shape with a substantially planar inwardly facing surface 564. Each pivot interface 560 also includes substantially cylindrical pivot interface aperture 566, which passes through a distal end of pivot interface 560 in a vertically centered location. Coupler 502 is manufactured such that pivot interface apertures 566 encircle respective pivots 542 in a location between inwardly facing surfaces 548 of stops 544 and the outwardly facing surfaces of walls 510. The diameter of pivot interface aperture 566 is greater than the diameter of pivot 542 and less than the diameter of stop 544. This relative sizing allows pivot interface aperture 566 to rotate about pivot 542 without disengaging therefrom.

As best depicted in FIGS. 5B and 5C, pivot interfaces 560 are coupled to the proximal ends of the outwardly facing surfaces of upper walls 510 of second arm 504b such that the vertical midpoints of pivot interfaces 560 and upper walls 510 align. Such coupling may be performed via any one of a variety of methods commonly known in the art including, but not limited to, welding, adhesive, etc. Pivot interfaces 560 are provided to allow second arm 504b to pivot relative to first arm 504a, thereby allowing the angle between arms 504a and 504b to be adjusted to conform to the angle of the frame of the portion of a side-by-side stroller located between the seats of such stroller. That is, pivot interfaces 560 and pivot assemblies 540 form a pivoting mechanism that pivotably couples arms 504.

To attach coupler 502 to a side-by-side stroller having a central bar or frame between the seats, coupler 502 is placed above the portion of the frame of the side-by-side stroller located between the seats. First arm 504a is then placed atop the bottom or top half of this section of the stroller frame and pressure is exerted onto top wall 508 such that the stroller frame enters the location between opposing walls 568, which causes expansion of walls 568 relative to each other. Additional pressure is exerted onto the upwardly facing surface of top wall 508 until the stroller frame begins to pass into cavity 532. At this point, the inward pressure exerted by walls 568 on the stroller frame (due to their desire to contract to their original position) causes the stroller frame to roll along the inwardly facing surfaces of walls 513 until it is located between top walls 510 and merely resting upon middle walls 513. Once the stroller frame is no longer exerting pressure on walls 568, the latter contracts to their original position. This contraction retains the stroller frame within cavity 532 and, consequently, retains first arm 504a coupled to the stroller. If necessary, the angle between first arm 504a and second arm 504b is then adjusted until it conforms to the angle of the particular side-by-side stroller to which coupler 502 is being attached. The process above is repeated with second arm 504b on the opposite half of the stroller frame. In this manner, coupler 502 is attached to a stroller in a manner that allows a barrier to be attached thereto via one of the methods discussed herein (e.g., adhesive).

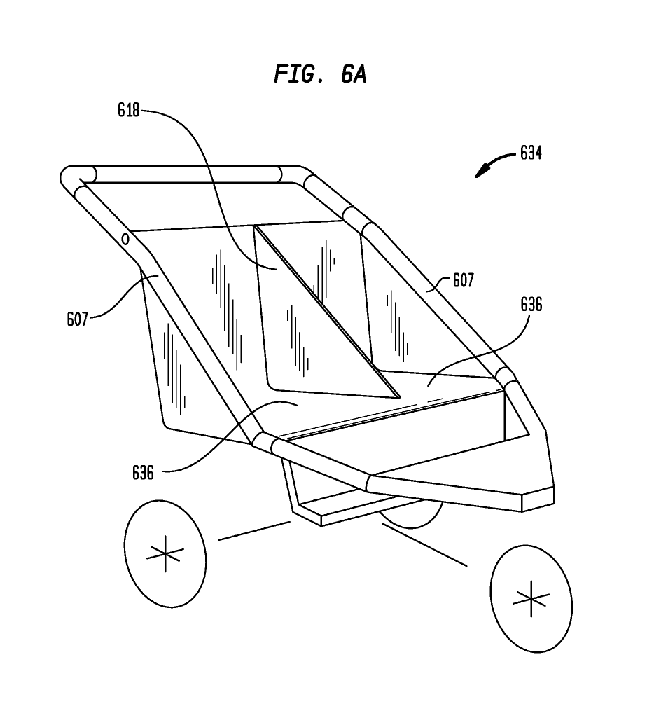

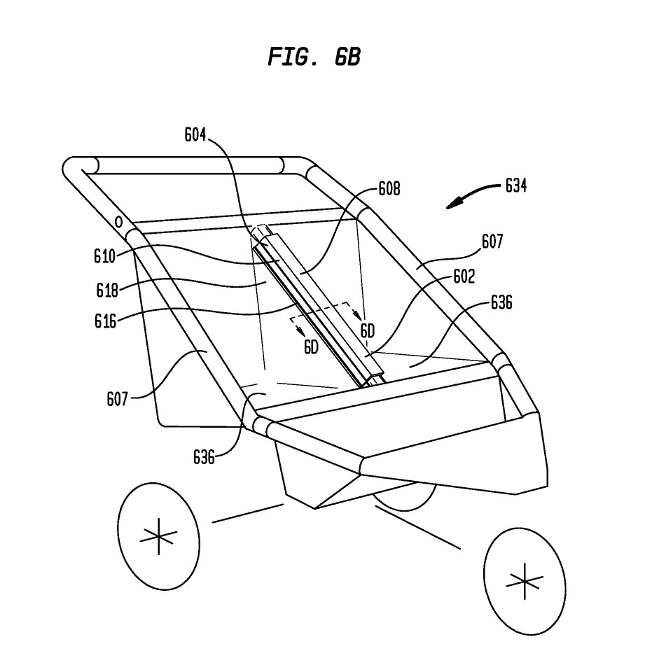

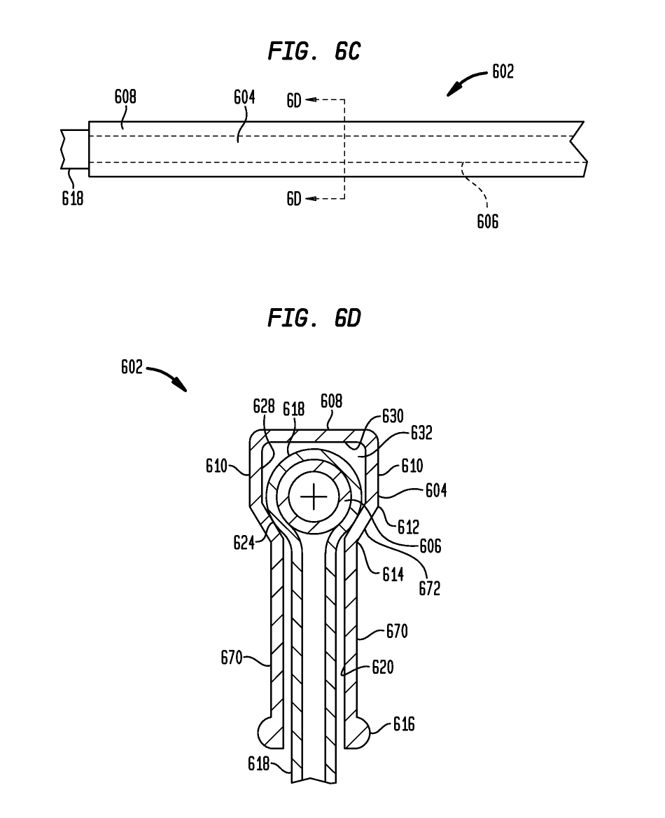

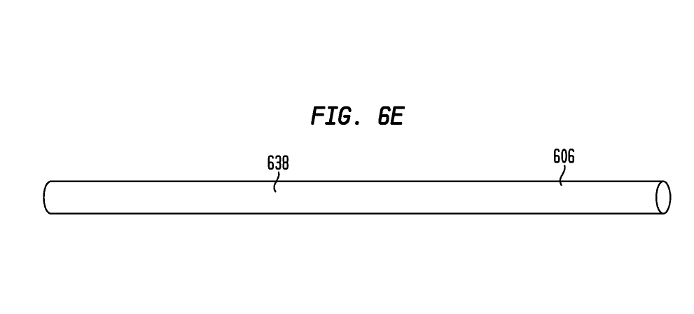

Turning now to FIG. 6B, depicted is an alternative clipping coupler 602 attached to a side-by-side stroller having fabric 618 but no frame between the seats such as stroller 634 as depicted in FIG. 6A. That is, coupler 602 is designed to conform to side-by-side strollers having no central frame or support bar and including two layers of fabric between which a support tube may be placed. Such strollers (e.g., jogging strollers) typically eliminate elements included in a typical stroller frame (e.g., frames between the seats) to minimize weight.

Referring now to FIGS. 6C and 6D, coupler 602 includes, inter alia, clip 604 and support tube 606. Clip 604 is substantially linear and has a substantially planar top wall 608. As depicted in FIG. 6D, substantially planar upper walls 610 extend downward in a manner substantially perpendicular from the outer longitudinal edges of top wall 608 until edge 612, at which they intersect longitudinally with middle walls 672. Middle walls 672 converge inward and downward until edge 614 at an angle of approximately 30 degrees. Then, at edge 614, substantially planar lower walls 670 extend downward in a manner substantially perpendicular to top wall 608.

Beads 616 are semi-spherical in shape and extend across the entire length of the bottommost outwardly facing edge of lower walls 670. Beads 616 are provided to strengthen the bottommost end of lower walls 670 when coupling clip 604 to a stroller as discussed in greater detail below. That is, beads 616 provide additional thickness to the material located at the bottommost outwardly facing edges of lower walls 670, which thereby adds additional strength. Inwardly facing surfaces 624, 628, and 630 of middle walls 672, upper walls 610, and top wall 608, respectively, bound cavity 632. As discussed in greater detail below, support tube 606 is retained within cavity 632 of clip 604 when coupler 602 is attached to a stroller.

Clip 604 is constructed of a material possessing sufficient flexibility to allow support tube 606 and one or more layers of fabric 618 located between the seats of a side-by-side stroller to pass between inwardly facing surfaces 620 as discussed in further detail below. Clip 604 may be manufactured from a material such as, but not limited to, polypropylene.

Depicted in FIG. 6E, support tube 606 is an elongated cylindrical body with an outwardly facing surface 638. In the depicted embodiment, support tube 606 is substantially the same length as clip 604. However, embodiments of the present invention are envisioned in which support tube 606 is shorter or longer than the length of clip 604. Support tube 606 may be molded from a material such as, but not limited to, acrylonitrile butadiene styrene (“ABS”).

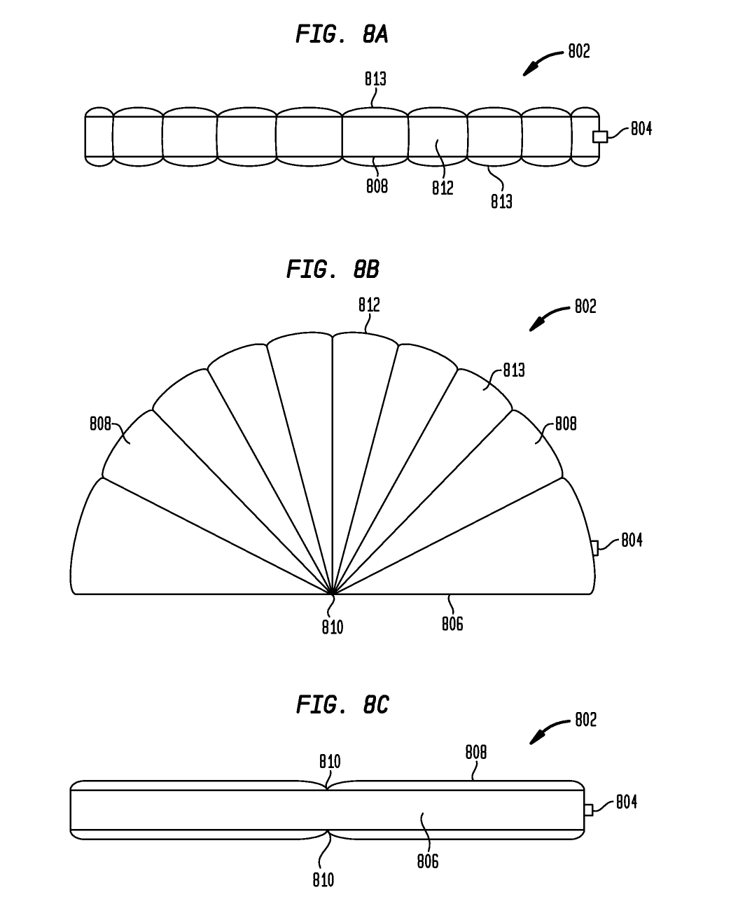

Referring now to FIGS. 6B and 6D, to attach coupler 602 to a side-by-side stroller having no central frame or support bar and including two layers of fabric, first support tube 606 is placed between the two layers of fabric 618 in a location that lies in the same plane as side frames 607 of stroller 634 and between seats 636 of stroller 634. Next, clip 604 is located directly above support tube 606 at approximately the same angle as support tube 606. Pressure is then exerted on top wall 608 and support tube 606 simultaneously such that support tube 606 and the fabric 618 surrounding support tube 606 enters the space between lower walls 670, thereby causing expansion of lower walls 670 relative to each other. The flexible nature of clip 604 allows lower walls 670 to be pushed apart by support tube 606 and its encircled fabric 618. Additional pressure is then exerted on top wall 608 and support tube 606 until support tube 606 begins to pass into cavity 632. At this point, the inward pressure exerted by lower walls 670 on support tube 606 and its encircled fabric 618 (due to their desire to contract to their original position) causes support tube 606 and its encircled fabric 618 to slide along the inwardly facings surfaces 624 of middle walls 672 until support tube 606 and its encircled fabric 618 is located between upper walls 610 and is merely resting on inwardly facing surfaces 624. Once support tube 606 and its encircled fabric 618 passes into cavity 632 and is no longer exerting outward pressure on lower walls 670, clip 604 contracts back to its original shape. This contraction retains support tube 606 and its encircled fabric 618 in cavity 632. In this manner, coupler 602 is removably attached to stroller 634 and retained thereon in a semi-rigid configuration such as depicted in FIG. 6B. After coupler 602 has been installed, a barrier may be attached to coupler 602 as described in greater detail below with respect to FIGS. 8A and 8B.

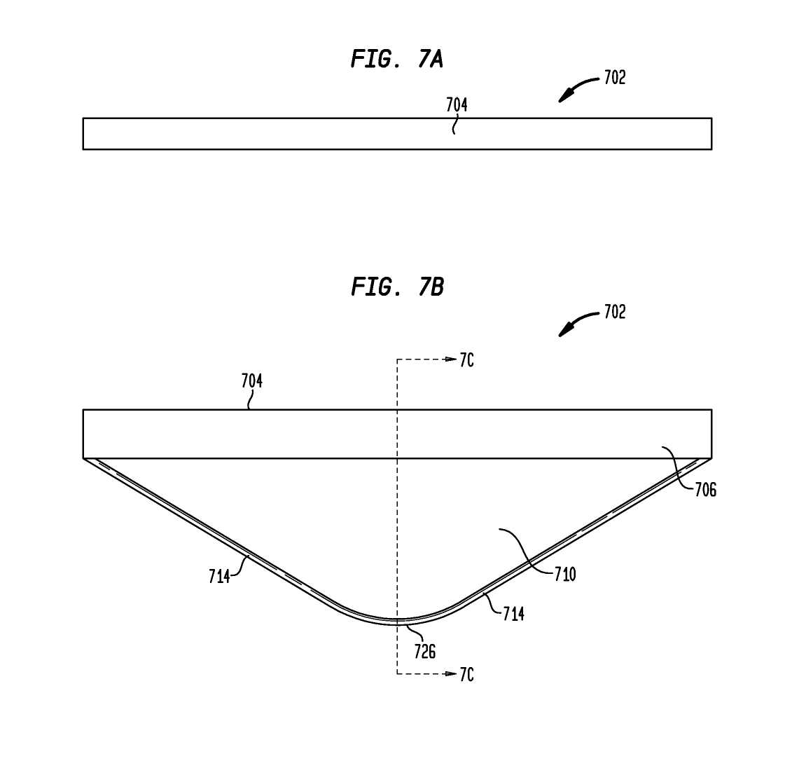

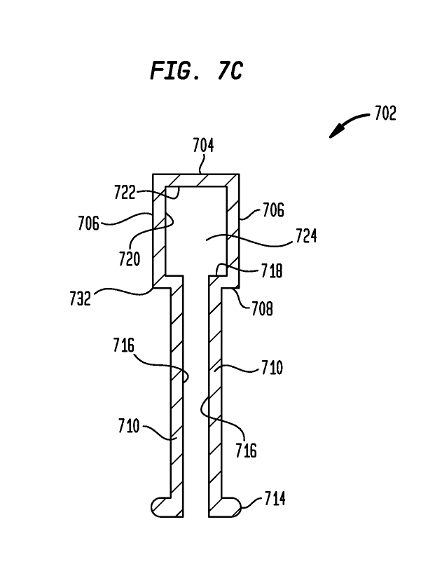

Turning now to FIGS. 7A and 7B, depicted is yet another clipping coupler 702 in accordance with an alternative embodiment of the present invention. Coupler 702 is also designed to for use with side-by-side strollers having fabric between the seats but no frame to which a coupler may be attached. Coupler 702 may be manufactured of a material such as, but not limited to, polypropylene. However, the present invention is not so limited. Coupler 702 may be constructed of any material possessing sufficiently flexibility to allow attachment of coupler 702 to a side-by-side stroller while also possessing sufficient rigidity to retain coupler 702 on a side-by-side stroller as further discussed below.

Referring now to FIGS. 7B and 7C, coupler 702 is substantially linear and has a substantially rectangular and planar top wall 704. As depicted in FIG. 7C, substantially planar upper walls 706 extend downward from the outer longitudinal edges of top wall 704 in a substantially perpendicular manner until edge 732, at which they intersect longitudinally with middle walls 708 in a substantially perpendicular manner. Middle walls 708 converge inward until they intersect with substantially planar lower walls 710. Best depicted in FIG. 7B, lower walls 710 are substantially triangular in shape with a rounded apex 726 located at the longitudinal midpoint of coupler 702. As best seen in FIG. 7C, lower walls 710 also have inwardly facing surfaces 716 that are located at a distance from one another that is approximately equal to twice the thickness of the type of fabric commonly used for manufacturing strollers.

Lower walls 710 proceed downward from middle walls 708 in a substantially perpendicular manner. Beads 714 are semi-spherical in shape and extend across the entire length of the bottommost outwardly facing edges of lower walls 710. Beads 714 are provided to strengthen the bottommost end of lower walls 710.

Inwardly facing surfaces 718, 720, and 722 of middle wall 708, upper wall 706, and top wall 704, respectively, bound cavity 724, which is provided to facilitate attachment of coupler 702 to the fabric of a side-by-side stroller as further discussed below. The distance between inwardly facing surfaces 720 is approximately double the distance between inwardly facing surfaces 716.

To attach coupler 702 to a side-by-side stroller having fabric but no frame between the seats such as the stroller depicted in FIG. 6A, the apexes 726 of lower walls 710 are placed over the uppermost edge(s) of the portion of fabric 618 located between seats 636. Pressure is then exerted onto wall 704 such that fabric 618 slides up into the space between lower walls 710. Downward force is applied to wall 704 until coupler 702 will not move further downward. That is, fabric 618 slides up between lower walls 710 until the topmost edge of fabric 618 enters cavity 724 and contacts inwardly facing surface 722. Additionally, inwardly facing surfaces 716 contact the portion of fabric 618 located between lower walls 710. In this manner, coupler 702 is removably attached to stroller 634 and retained thereon. After coupler 702 has been installed, a barrier may be attached to coupler 702 as described in greater detail below with respect to FIGS. 8A and 8B.

As previously discussed above, lower walls 710 are substantially triangular and extend downward from middle walls 708 of coupler 702. Lower walls 710 are triangular in order to maximize contact between lower walls 710 and fabric 618 located between seats 636. That is, many side-by-side strollers that do not have frame elements between the seats include triangular fabric between the seats to accommodate the most common configuration of the side-by-side stroller as is commonly known in the art and as depicted in FIG. 6A. Therefore, the triangular shape of lower walls 710 provides rigidity to the position of coupler 702 by covering the entire area of fabric 618.

Turning now to FIGS. 8A and 8B, depicted is an inflatable obstruction 802 in accordance with one embodiment of the present invention. Inflatable obstruction 802 is designed to be inflated (e.g., blown up by a user) when required to provide a barrier between occupants in a side-by-side stroller and deflated for storage when not in use. Inflatable obstruction 802 is constructed of a material capable of withstanding repeated inflation and deflation such as, but not limited to, vinyl.

Inflatable obstruction 802 has an air inlet 804 through which a user may blow air in order to inflate obstruction 802. Inflatable obstruction 802 also has a substantially rectangular and planar downwardly facing surface 806, the latter of which is best depicted in FIG. 8C. Best depicted in FIG. 8B, inflatable obstruction 802 has a plurality of triangularly shaped sections 808 that fan out from a center axis 810. That is, each triangularly shaped section 808 has an apex located at center axis 810 and radiates outward from center axis 810 to allow a plurality of sections 808 to collectively form a semi-circular shape. Each section 808 has sides 813 that have a semi-ovate latitudinal profile. Each section 808 also includes upwardly facing surfaces 812 that extend upward in a semi-ovate shape. The chambers internal to each of sections 808 are in communication with each other to allow obstruction 802 to be fully inflated by blowing air through air inlet 804.

Obstruction 802 may be coupled to any of the couplers discussed above via attachment of downwardly facing surface 806 to the coupler. For example, obstruction 802 may be coupled to a coupler such as clipping coupler 502 by applying an adhesive such as, but not limited to, vinyl cement to downwardly facing surface 806. The adhesive readied surface 806 is then held in communication with the upwardly facing surface of top wall 508 until the adhesive dries. This method of attachment may also be used to attach downwardly facing surface 806 (and therefore inflatable obstruction 802) to the upwardly facing surface of top wall 608 or top wall 704 of clipping coupler 602 or coupler 702, respectively. However, alternative attachment methods may be substituted without departing from the scope of the present invention such as, but not limited to, riveting.

Additionally, to couple inflatable obstruction 802 to telescoping coupler 104 or tension coupler 400, an attachment mechanism such as attachment mechanism 312 of obstruction 102 may be employed. That is, a plurality of flat straps including hooks on one side and loops on the other may be coupled to downwardly facing surface 804 in the same configuration discussed in further detail above with reference to attachment mechanism 312 and straps 314 of obstruction 102. However, alternative attachment methods may be substituted without departing from the scope of the present invention.

In addition, alternative embodiments of the present invention are envisioned in which an obstruction is provided that does not collapse or deflate for storage. For example, a non-collapsible, non-deflatable obstruction having the same shape as obstruction 802 is envisioned wherein such obstruction is made of hard, non-deformable plastic or the like in a fixed configuration. Such an obstruction may have a semicircular shape or a shape that approximates the area between the upper and lower portions of a central frame located between the seats of a side-by-side stroller. Barrier may be constructed of a material possessing sufficient strength to provide an effective barrier between occupants of a side-by-side stroller such as, but not limited to, vinyl coated fabric.

Additionally, such a barrier may include a substantially planar, substantially rectangular downwardly facing surface similar to that of obstruction 802 as depicted in FIG. 8C. The downwardly facing surface of the obstruction may be attached to clipping coupler 502, alternative clipping coupler 602, or coupler 702 via an adhesive as described in detail above with regards to inflatable barrier 802 and FIGS. 8A-8C. Additionally, the downwardly facing surface of the obstruction may be attached to telescoping coupler 104, tension coupler 400, or a similar coupler via a hook and loop attachment mechanism as discussed in further detail above with regards to collapsible barrier 102 and FIGS. 3A-3D. However, alternative attachment methods may be substituted without departing from the scope of the present invention.

Referring back to FIG. 3D, collapsible barrier 102 may also be attached to clipping coupler 502, alternative clipping coupler 602, or coupler 702 via an adhesive. In such a scenario, straps 314 are omitted and an adhesive may be applied to outwardly facing surfaces 310 and 320 of movable arm 306 and storage arm 318, respectively, in order to couple collapsible barrier 102 to the upwardly facing surfaces of top wall 508 of clipping coupler 502, top wall 608 of alternative clipping coupler 602, or top wall 704 of coupler 702.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An apparatus for creating a barrier between occupants of a side-by-side stroller comprising:
two arms;
two length adjusters, each of said length adjusters attached to a respective one of said two arms;
a pivoting mechanism, said two arms pivotably coupled to each other via said pivoting mechanism;
two stroller interfaces, each of said stroller interfaces coupled to one of said two arms;
an obstruction coupled to at least one of the group consisting of one or more of said two arms; one or more of said stroller interfaces, and combinations thereof.

2. An apparatus according to claim 1, wherein said obstruction is coupled to said at least one of the group consisting of one or more of said two arms; one or more of said stroller interfaces, and combinations thereof via one or more straps.

3. An apparatus according to claim 1, wherein said obstruction is selected from the group consisting of a fixed shape, inflatable, and collapsible.

4. An apparatus according to claim 1, wherein said two length adjusters are selected from the group consisting of collars and an elastic cord.

5. An apparatus for creating a barrier between occupants of a side-by-side stroller comprising:
two clipping arms;
a pivoting mechanism, said two clipping arms pivotably coupled to each other via said pivoting mechanism; and
an obstruction coupled to said two arms.

6. An apparatus according to claim 5, wherein said obstruction is coupled to said two arms via an adhesive.

7. An apparatus according to claim 5, wherein said obstruction is at least one of the group consisting of a fixed shape, collapsible, and inflatable.

8. An apparatus according to claim 1 further comprising:
a support tube.

9. A method for installing a barrier between occupants of a side-by-side stroller comprising the steps of:
adjusting an angle between two arms of said barrier, said barrier including:
said two coupler arms;
two length adjusters, each of said length adjusters attached to a respective one of said two coupler arms;
a pivoting mechanism, said two coupler arms pivotably coupled to each other via said pivoting mechanism;
two stroller interfaces, each of said stroller interfaces coupled to one of said two coupler arms; and
an obstruction coupled to at least one of the group consisting of one or more of said two coupler arms; one or more of said stroller interfaces, and combinations thereof;
securing said first angle;
adjusting a first length of a first of said two coupler arms;
coupling a first of said two stroller interfaces to a frame of said stroller;
securing said first length;
adjusting a second length of a second of said two coupler arms;
coupling a second of said two stroller interfaces to a frame of said stroller;
securing said second length; and
attaching said obstruction to said at least one of the group consisting of one or more of said two coupler arms; one or more of said stroller interfaces, and combinations thereof.

10. A method according to claim 9 further comprising the step of:
adjusting a second angle between two obstruction arms of said obstruction; and
securing said second angle.
